(19) United States
(12) Patent Application Publication
(10) Pub. No.: US 2001/0053976 A1
(43) Pub. Date: Dec. 20, 2001

(54) On line conversation program and method

(76) Inventor: Henry Olko, West Cornwall, CT (US)

Correspondence Address: FITZPATRICK CELLA HARPER & SCINTO, 30 ROCKEFELLER PLAZA, NEW YORK, NY, 10112, US

(21) Appl. No.: 09/877,041

(22) Filed: Jun. 11, 2001

Related U.S. Application Data
(60) Provisional application No. 60/211,467, filed on Jun. 15, 2000.

(51) Int. Cl. G10L 21/00; G10L 11/00

(52) U.S. Cl. 704/270

(57) ABSTRACT

A method and software are disclosed for providing a simulated interactive conversation in which searchable information is stored in a database in the form of text and/or oral recorded statements along with stored images of selected individuals or animated characters to whom questions are posed by the user through a user interface. The database is then searched, based on the wording of the question, for an appropriate response which is then provided to user either in text form or orally with lip sincing of said image.

### BACKGROUND OF THE INVENTION

### CROSS REFERENCE TO RELATED APPLICATION

This application claims the benefit of Provisional Application No. 60/211,467 filed Jun. 15, 2000, the disclosure of which is incorporated herein by reference.

### FIELD OF THE INVENTION

The present invention relates to the area of interactive computer software and more particularly to a method and software that enable a user to conduct a simulated conversation with living, deceased or imaginary personalities or characters.

### BACKGROUND OF THE INVENTION

There are many sources on the internet or otherwise for obtaining in depth information. While demand for online information skyrockets, present offerings, especially for students, remain impersonal, scattered and boring. Moreover, although information gathering through the Internet is an established fact, there is ample opportunity for entry and growth, particularly if an offering satisfies a heretofore unavailable need or desire. This gathering of knowledge and information is a never-ending task, with continued growth possibilities. However, there are no software programs or services currently available which are focused on obtaining information, through simulation from a particular character or personality. For example there is a plethora of information available on the internet about George Washington but no program or service that enables the user to get such information through a simulated conversation with him.

Accordingly, it is an object of the present invention to provide program or software subscribers a direct interactive method of communication with personalities and characters-living, deceased or imaginary for the purpose of obtaining information from them about their lives and times.

### SUMMARY OF THE INVENTION

In accordance with an aspect of the present invention a method and related software programs are provided for use on the internet through an internet service company or the like which provides an interactive service enabling the user to simulate a personal communication with past or current, real or fictional, famous people/characters to obtain from them in-depth information, via voice and visual animated lip movement. The conversation can be conducted through typed in questions or through Spoken Language Systems (SLS) and language translation.

### DESCRIPTION OF THE PREFERRED EMBODIMENT

The method of the present invention will be carried out as a service from an internet web site at which a resource library of information (or database) is stored about the lives and times of historical individuals or personalities such as Elvis Presley, Joe DiMaggio, Kennedy, Nixon, Peanuts, Washington, Napoleon, Michaelangelo, Mozart, Babe Ruth, etc.

The information is stored as searchable text or as searchable sound bites of text. The software program permits the user to identify the personality with whom a conversation is to be held and to then question the personality by typing questions into the users computer or orally using sound recognition software. The program then searches the resource library for an appropriate response to the question asked.

The resource library may contain film clips of the personality or computer generated images so that the personality's image appears on the users computer monitor to provide a simulated communication with the selected personality or character, featuring both a visual and a voice-lip-sinc response.

The method and software of the invention can be provided in different levels of complexity for example:

1. Basic For Students through grade 6

2. Intermediate For Students - grades 7-12

3. Advanced College and those searching for additional in-depth information.

Basic, for a younger audience, requires “simpler” less diversified programs, enabling an early market introduction. Intermediate and Advanced, will use more complex programs.

The information stored in the resource library can be based on the following guidelines:

1. Parallelling school curriculums

2. Customer feedback and requests

3. Utilizing information sources, .e. Time/Life Magazines in identifying personalities i.e. notable people of the century/millennium etc.

4. Licensed films and interviews with personalities and characters.

There are no known programs or services offering a method of direct interactive communication such as that provided by the present invention.

The information contained in the resource library may include printed information from current and historical information sources categorized in a menu listing, i.e. Political-Military-Art-Architecture-Music-Literature-Stage-Screen-Sports-Cartoons etc. In the case of musicians or composers, their music will be available. Drawings, photos, paintings and pictures relevant to Personalities and Characters will also be catalogued and made available.

The program may include a program host having an animated voice lip movement. The host may ask the user questions about the research he or she wishes to conduct and offer assistance in contacting personalities and characters. The “host” may always be available for assistance, or the user may offer a choice of proceeding with or without the host's assistance.

The method and software of the present invention is designed and constructed to operate generally as follows.

1. Initial Program Registration

Input

a. Name

b. Address

c. Telephone Number

d. E-mail address

e. Password-To be used primarily as a control for Teachers, Schools and Libraries

f. Greeting identification name-Name used by Program Host in greeting subscriber

2. Log on Program

a. Personal greeting by “Host” with voice and animated lip movement

b. Host questions subscribers as to whom subscribers wishes to speak, or if subscriber would like to see the Personality/Character Category menu.

c. Subscriber answers by mouse keyboard or by voice, “Yes-No.”.

d. Personality/Character Category menu appears

e. Click on Personality/Category desired, a list of current available Personalities and Characters in selected category appears.

3. Select Personality/Character

a. Personality/Character selection by mouse, keyboard or voice; Host says the name and asks subscriber to repeat the name if desired, for future direct voice contact

b. The “Likeness” (photo-drawing, etc.) of the selected Personality appears with a personal greeting and asks “How can I help you-what would you like to know”?

4. Questioning

a. By typed questions or voice recognition (SLS).

5. Reply by Personality/Character

a. Answers are given in the first person “I”, with animated lip voice response. Response will reflect characteristics of Personality/Character

b. If desired, printed answers can be requested by mouse, keyboard or voice “Print”

c. A series of answers will be available to Personality/Character for unanswerable questions-Unclear requests will be asked to be rephrased.

6. Close Program

a. Program closed by mouse, keyboard or voice.

b. “Host” appears with remarks, i.e. “I hope you enjoyed your conversation, do you wish to quit the program or is there anyone else to whom you would like to speak”. Host also asks if there are any comments subscriber would like to make or any Personality/Character not available not that subscriber would like to meet. Subscriber replies by mouse and/or written comments.

c. Comments made by subscriber will assist in furthering Resource Library development.

As should be apparent to those skilled in the art the present invention provides a very useful tool, particularly for the student market which is always in search of information for school programs, general interest and entertainment. Schools, teachers and libraries are constantly searching for means of encouraging student's interest. In today's highly competitive world, parents, schools and government leaders are demanding higher academic achievement. Together, they are taking a more active role in meeting educational needs.

The present invention is directed toward these needs.

Although the present invention has been described herein with reference to a particular embodiment, it is to be understood that the invention is not limited to that embodiment and that various changes and revisions may be made therein by those skilled in the art without departing from the scope or spirit of this invention.

What is claimed is:

1. The method of providing a simulated interactive conversation comprising the steps of:
a. storing in a database searchable information in the form of text and/or oral recorded statements;
b. providing in the database stored images of selected individuals or animated characters.
c. using questions provided through a user interface to search the database for an appropriate response and providing the response to the user.

2. The method as defined in claim 1 wherein the step of providing the response comprises providing the response orally with lip sincing of said image.

3. A software program for carrying out the methods of claims 1 and 2.
